(19) United States
(12) Patent Application Publication
(10) Pub. No.: US 2026/0199783 A1
(43) Pub. Date: Jul. 16, 2026

(54) METHOD AND APPARATUS FOR PROCESSING AUDIO INFORMATION IN GAME, AND STORAGE MEDIUM

(71) Applicant: NETEASE (HANGZHOU) NETWORK CO., LTD., Hangzhou, Zhejiang (CN)

(72) Inventor: Xinyue LIANG, Foshan, Guangdong (CN)

(73) Assignee: NETEASE (HANGZHOU) NETWORK CO., LTD., Hangzhou, Zhejiang (CN)

(21) Appl. No.: 19/132,048

(22) PCT Filed: May 12, 2023
(86) PCT No.: PCT/CN2023/094005

§ 371 Date: May 22, 2025

(30) Foreign Application Priority Data
Nov. 22, 2022 (CN) 202211465571.3

(51) Int. Cl. A63F 13/54; G06F 3/16; G10H 1/00

(52) U.S. Cl. CPC A63F 13/54; G06F 3/165; G10H 1/0008; G10H 1/0041; G10H 2210/026; G10H 2240/141; G10H 2240/145

(57) ABSTRACT

A method for processing audio information in a game includes determining a music attribute of game music to be made in the game, where the music attribute is set to characterize a target operation phase of the game; invoking a music element library matching the game, where the music element library includes a plurality of music elements, and each of the music elements is set to characterize game operation information of the game in a corresponding operation phase; obtaining, from the music element library, at least one target music element matching the music attribute; and outputting the at least one target music element to a music making end, where the at least one target music element is set to be made on the music making end into the game music, and the game music is set to prompt game operation information in the target operation phase.

### CROSS-REFERENCE TO RELATED APPLICATIONS

The present disclosure is a U.S. National Phase Application of International Application No. PCT/CN 2023/094005, filed on May 12, 2023, which claims the priority to the Chinese Patent Application No. 202211465571.3, entitled “METHOD AND APPARATUS FOR PROCESSING AUDIO INFORMATION IN GAME, AND STORAGE MEDIUM”, filed on Nov. 22, 2022, and the entire contents of both of which are incorporated herein by reference.

### TECHNICAL FIELD

The present disclosure relates to the field of information processing technology, and specifically, to a method and an apparatus for processing audio information in a game, and a storage medium.

### BACKGROUND

Currently, game music used in a game on a market mainly consists of interface music, scene music, battle music, plot music, animation music, and so on. The design of the described game music is usually completed based on some music clips that have already been created, and each piece of music in the game may be an independent individual.

It should be noted that the information disclosed in the background section described above is only used for enhancement of understanding for the background of the present disclosure, and thus may include information that does not constitute prior art known to those ordinary skilled in the art.

### SUMMARY

The present disclosure provides a method and an apparatus for processing audio information in a game, and a storage medium.

According to an embodiment of the present disclosure, there is provided a method for processing audio information in a game, including: determining a music attribute of game music to be made in the game, where the music attribute is set to characterize a target operation phase of the game; invoking a music element library matching the game, where the music element library includes a plurality of music elements, and each of the music elements is set to characterize game operation information of the game in a corresponding operation phase; obtaining, from the music element library, at least one target music element matching the music attribute; and outputting the at least one target music element to a music making end, where the at least one target music element is made on the music making end into the game music, and the game music is set to prompt game operation information in the target operation phase.

According to an embodiment of the present disclosure, there is further provided a computer-readable storage medium. The computer-readable storage medium stores a computer program, where the computer program is set to perform, when it is run, the method for processing audio information in a game in any of the above.

According to an embodiment of the present disclosure, there is further provided an electronic device including a memory and a processor, where the memory stores a computer program, and the processor is set to run the computer program to perform the method for processing audio information in a game in any of the above.

### BRIEF DESCRIPTION OF THE DRAWINGS

The accompanying drawings illustrated herein are used for providing a further understanding for the present disclosure, and form a part of the present disclosure. The schematic embodiments of the present disclosure and their description are used for explaining the present disclosure, and do not constitute an undue limitation to the present disclosure. In the accompanying drawings:

FIG. 1 is a block diagram of a hardware structure of a mobile terminal of a method for processing audio information in a game in an embodiment of the present disclosure.

FIG. 2 is a flowchart of a method for processing audio information in a game according to an embodiment of the present disclosure.

FIG. 3 is a flowchart of a method for automatically constructing game music by using a music palette according to an embodiment of the present disclosure.

FIG. 4 is a schematic diagram of a basic palette according to an embodiment of the present disclosure.

FIG. 5 is a schematic diagram of another basic palette according to an embodiment of the present disclosure.

FIG. 6 is a schematic diagram of another basic palette according to an embodiment of the present disclosure.

FIG. 7 is a schematic diagram of another music palette corresponding to game music according to an embodiment of the present disclosure.

FIG. 8 is a schematic diagram of an apparatus for processing audio information in a game according to an embodiment of the present disclosure.

FIG. 9 is a schematic diagram of an electronic device according to an embodiment of the present disclosure.

### DETAILED DESCRIPTION

In order to enable those skilled in the art to better understand the solutions of the present disclosure, the technical solutions in the embodiments of the present disclosure will be described clearly and completely in the following in conjunction with the accompanying drawings in the embodiments of the present disclosure. It is apparent that the described embodiments are only a part of the embodiments of the present disclosure, but not all of the embodiments. Based on the embodiments in the present disclosure, all other embodiments obtained by those ordinary skilled in the art without making creative labor should fall within the scope of protection of the present disclosure.

It should be noted that the terms “first”, “second”, etc. in the specification, claims and the above-described accompanying drawings of the present disclosure are used for distinguishing between similar objects, but do not necessarily describe a specific order or sequence. It should be understood that the data used in this way may be interchanged, where appropriate, facilitating that the embodiments of the present disclosure described herein can be implemented in an order other than those illustrated or described herein. In addition, the terms “include” and “have”, and any variations thereof, are intended to cover non-exclusive inclusion, e.g., a process, a method, a system, a product, or an apparatus including a series of steps or units is not necessarily limited to those steps or units that are clearly listed, but may include other steps or units that are not clearly listed or that are inherent to those processes, methods, products or apparatuses.

In a possible embodiment, in the field of information processing technology, for the design of the game music, the method usually adopted is to select, from the music clips that have already been created, the music that is more compatible with the game scene in the game as the game music, and when there is a new scene or a new plot in the game, it is only required to select, from the music clips that already exist, the music that is compatible with the newly added scene or the newly added plot. However, there is not much correlation between the game music obtained through this game music design method, and each piece of music may be an independent individual, which may cause the technical problem of disunified styles and tones of the game music. Based on this, the embodiments of the present disclosure provide a method for processing audio information in a game, where a music attribute of game music to be made in the game is first determined, the music attribute may be set to characterize a target operation phase of the game, then, a music element library matching the game may be invoked, where the music element library includes a plurality of music elements, and each of the music elements is set to characterize game operation information of the game in a corresponding operation phase; and at least one target music element matching the music attribute may be obtained from the music element library, and thus the at least one target music element is output to a music making end, where the at least one target music element is set to be made on the music making end into the game music, and the game music is set to prompt the game operation information in the target operation phase. Since the game music is completed through design based on the music element library matching the game, the style of the game music is relatively unified, which is conducive to the creation of an overall unified game worldview, achieving the purpose of unifying the style of the game music, and realizing the technical effect of enriching the game music making method.

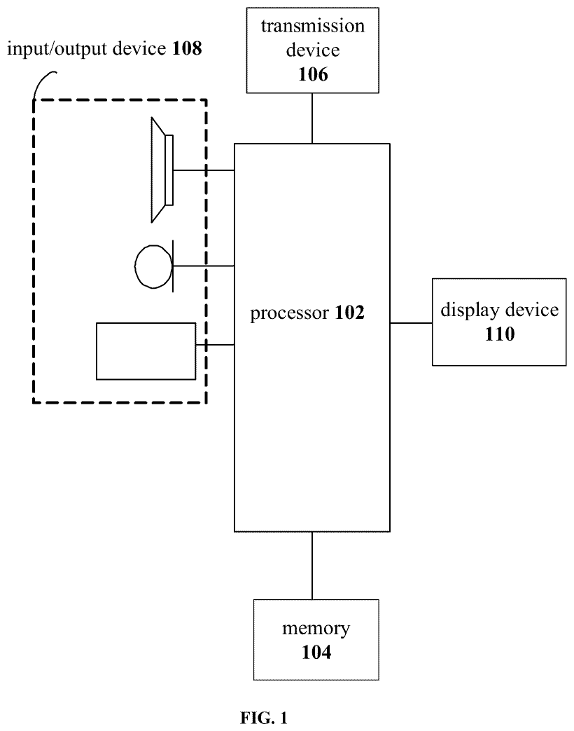

The above method embodiments involved in the present disclosure may be performed in a mobile terminal, a computer terminal, or a similar computing device. Taking the above method embodiments running on a mobile terminal as an example, the mobile terminal may be a terminal device such as a smartphone, a tablet computer, a palmtop computer, a mobile Internet device, a PAD, a game console, and the like. FIG. 1 is a block diagram of a hardware structure of a mobile terminal of a method for processing audio information in a game in an embodiment of the present disclosure. As shown in FIG. 1, the mobile terminal may include one or more (only one is shown in FIG. 1) processors 102 (the processor 102 may include, but is not limited to, a processing device such as a central processing unit (CPU), a graphics processing unit (GPU), a digital signal processing (DSP) chip, a microprocessor (microcontroller unit, MCU), a programmable logic device (field-programmable gate array, FPGA), a neural network processing unit (NPU), a tensor processing unit (TPU), and an artificial intelligence (AI) type processor) and a memory 104 used for storing data. In an embodiment of the present disclosure, the mobile terminal may further include a transmission device 106 for a communication function, an input/output device 108, and a display device 110.

In some optional embodiments that focus on game scenes, the above device may further provide a human-computer interaction interface with a touch surface. The human-computer interaction interface may sense finger contact and/or gestures for human-computer interaction with a graphical user interface (GUI). The human-computer interaction function may include the following interaction: creating web pages, drawing, word processing, making electronic documents, gaming, video conferencing, instant messaging, sending and receiving emails, calling interfaces, playing digital videos, playing digital music, and/or web browsing, etc. Executable instructions for executing the above human-computer interaction functions are configured/stored in one or more processor-executable computer program products or readable storage media.

Those skilled in the art can understand that the structure shown in FIG. 1 is merely illustrative, and does not limit the structure of the mobile terminal described above. For example, the mobile terminal may include more or fewer components than that shown in FIG. 1, or have a different configuration than that shown in FIG. 1.

According to an embodiment of the present disclosure, there is provided an embodiment of a method for processing audio information in a game. It should be noted that the steps shown in the flowchart of the accompanying drawings may be performed in a computer system such as a set of computer-executable instructions, and that, although a logical order is shown in the flowchart, in some cases, the steps as shown or described may be performed in a different order from that shown herein.

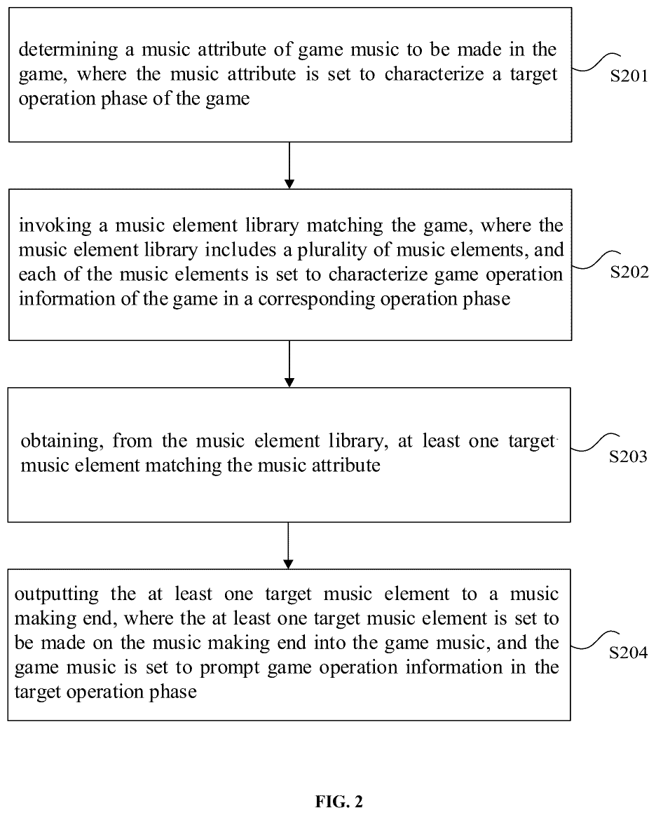

In a possible embodiment, the embodiments of the present disclosure provide a method for processing audio information in a game. FIG. 2 is a flowchart of a method for processing audio information in a game according to an embodiment of the present disclosure. As shown in FIG. 2, the method may include the following steps S201 to S204.

At step S201, a music attribute of game music to be made in the game is determined, where the music attribute is set to characterize a target operation phase of the game.

In the technical solution provided in the above step S201 of the present disclosure, the game music is background music used in the game, and may include interface music, battle music, plot music, scene music, theme music, animation music, and the like. Each type of the game music corresponds to a music attribute. The music attribute is set to characterize a target operation phase in which the game is currently running, e.g., the interface game music attribute is set to characterize that the target operation phase of the game is a player login phase.

In an embodiment, in the determination of the music attribute of the game music to be made in the game, the game music to be made in the target operation phase may be determined according to the target operation phase of the game to which the game music to be made is to be applied, and then the game music attribute corresponding to the game music is determined according to the game music to be made.

At step S202, a music element library matching the game is invoked, where the music element library includes a plurality of music elements, and each of the music elements is set to characterize game operation information of the game in a corresponding operation phase.

In the technical solution provided in the above step S202 of the present disclosure, a plurality of music element libraries may be established. Each music element library may correspond to a game type. In some embodiments, the game type may include an action type game, an adventure type game, a simulation type game, a role playing type game, and the like. Based on this, after the music attribute of the game music to be made in the game is determined, the music element library matching the game may be invoked, and then the game music is established based on the music element library. In some embodiments, matching means that the game type of the game is consistent with the game type corresponding to the music element library.

In an embodiment, in the establishment of the music element library, a plurality of music element type sets may be obtained, such as a musical instrument symbol set, a musical instrument hint set, an orchestration set, a special design set, or an easter egg design set. In some embodiments, the musical instrument symbol set mainly includes a musical instrument corresponding to a main melody in the game music. The musical instrument hint set mainly includes a musical instrument or a musical instrument group corresponding to an ambient layer in the game music. The orchestration set mainly includes a musical instrument or a sound corresponding to a melody layer, a percussion layer and a rhythm layer in the game. The special design set mainly includes a musical instrument corresponding to a special plot or a special gameplay in the game. The easter egg design set mainly includes a musical instrument or a sound corresponding to a special scene or a special plot in the game. In some embodiment, each music element type set is set to indicate an expression type of a corresponding music element for the game operation information in the operation phase. Each music element type set may include different music element sub-types. For example, the musical instrument symbol set may include a musical instrument used by a protagonist in the game, a musical instrument used by a hostile group in the game, a musical instrument corresponding to a plot keyword in the game, a musical instrument corresponding to a game worldview keyword, etc. Different music element sub-types express different contents for the game operation information in the game operation phase. Music elements conforming to each music element type set may be organized into a music element library. In some embodiments, the music element library may be referred to as a music palette library or a music palette system.

In an embodiment, the music element library may be updated. For example, a plurality of music element type sets may be adjusted; and the music element library may be updated based on the music element type sets as adjusted.

In an embodiment, each music element library may correspond to a game type. Based on this, a music element library corresponding to a game type that is consistent with the game type may be determined, based on the game type of the game, from a plurality of music element libraries, and then the music element library may be used as the music element library matching the game, and the music element library may be invoked.

At step S203, at least one target music element matching the music attribute is obtained from the music element library.

In the technical embodiment provided in the above step S203 of the present disclosure, after the music element library is determined, at least one target music element matching the music attribute may be further obtained from the music element library.

In this embodiment, after the music element library is determined, tone information in the music attribute may be determined based on the music attribute of the game music to be made, and at least one target music element may be selected, based on the tone information, from the music element library. In some embodiments, the tone information is set to indicate a style tone, a scene ambience tone, an emotional tone, or an audio tone of the game music played in the target operation phase.

For example, assuming that the game music to be made is the interface music of the game, then, after the music element library corresponding to the game is determined, the tone information in the attribute of the interface music may be determined based on the attribute of the interface music to be made, that is, the style tone, the scene ambience tone, the emotional tone, or the audio tone in the attribute of the interface music may be determined.

In an embodiment, after the tone information in the music attribute is determined, at least one music element type set conforming to the tone information may be further determined, and at least one target music element may be selected, based on the at least one music element type set, from the music element library, where each music element type set is set to indicate an expression type of a corresponding music element for the game operation information in the target operation phase.

In an embodiment, in the selecting of at least one target music element from the music element library based on at least one music element type set, at least one target music element sub-type matching the game operation information in the target operation phase may be determined from the at least one music element type set respectively, where different target music element sub-types express different contents of the game operation information in the target operation phase. For example, when the music element type set selected from the music element library is a main melody music set, and the target music element sub-type selected from the main melody music set is a musical instrument used by the protagonist, the protagonist of the game appears when the game music corresponding to the musical instrument is played. Based on this, the at least one target music element may be obtained by selecting in the music element library a target music element belonging to each target music element sub-type.

At step S204, the at least one target music element is output to a music making end, where the at least one target music element is set to be made on the music making end into the game music, and the game music is set to prompt game operation information in the target operation phase.

In the technical solution provided in the above step S204 of the present disclosure, after the target music element is determined, the at least one target music element may be output to the music making end, and the music making end, after receiving the target music element, may make the game music based on the target music element, where the game music is set to prompt the game operation information in the target operation phase. The game operation information includes at least one of the following of the game: a group to which a virtual game character belongs, a game keyword, a game theme, a match quarter, a game plot, a game style, and a game operation.

In an embodiment, an audio play result corresponding to each target music element may be determined first, and in response to the audio play result satisfying a target audio play result corresponding to the game music, the at least one target music element is output to the music making end.

In an embodiment, in the determination of the audio play result corresponding to each target music element, the audio play result may be obtained by controlling an audio playing tool corresponding to each target music element to play, and/or the audio play result may be obtained by playing a target natural audio corresponding to each target music element.

For example, if the audio playing tool corresponding to the target music element is a musical instrument, e.g., a piano, the piano may be controlled to play a preset track to obtain the audio play result. If the target music element corresponds to a target natural audio, e.g., a metal percussion sound or a natural sound, the pre-recorded target natural audio may be played directly to obtain the audio play result.

In an embodiment, since the music element is set to characterize the game operation information of the game in the corresponding operation phase, based on which, after the music making end makes the game music based on the target music element, the game music may also be set to prompt the game operation information in the target operation phase.

For example, since the music element is set to characterize the game operation information of the game in the corresponding operation phase, i.e., there is a correspondence between the music element and the game operation information, based on which, there is also a correspondence between the game operation information and the game music made by the music making end based on the music element, and after the music making end makes the game music, the user may obtain the correspondence between the game music and the game operation information. In this way, when the user hears the game music in the course of the game, the user can perceive the game operation information in the current operation phase.

For example, since the game operation information at least includes one of the following: a group to which a virtual game character belongs, a game keyword, a game theme, a match quarter, a game plot, a game style, and a game operation, based on which, when the game operation information of the target operation phase is the game keyword “perish” and the music element corresponding to the game keyword is “erhu”, then after the music making end makes the game music based on the music element “erhu”, when the game music is played in the game, the user may perceive that the game operation information of the current operation phase of the game is rather sad, which corresponds to the game operation information of the game operation phase, achieving the purpose of prompting, based on game music, the game operation information of the target operation phase of the game.

For example, when the game operation information of the target operation phase includes the game style, the game style is the “suspense adventure type game”, and the music element corresponding to the game style is the harp and the string, then after the music making end makes the game music based on the music element, when the game music is played, the user may perceive the game operation information, with a sense of dilapidation and mystery, of the current operation phase of the game, which corresponds to the game operation information of the game.

In an embodiment, after the music making end makes the game music, the music making end may add a music label for each piece of game music. The music label may be set to indicate the game operation information of the target operation phase of the game. The music label may be displayed on a game interface corresponding to the corresponding game operation phase. Based on this, even if the game music is not played in the course of the game, the user may obtain, through the music label displayed on the game interface, the game operation information of the current operation phase of the game. Of course, other prompting manners may also be used to prompt, based on the game music, the game operation information of the game operation phase, and no specific limitation is made herein.

In at least a part of the embodiments of the present disclosure, the music element library may be established, the music element library may include a plurality of music elements, and each music element is set to characterize the game operation information of the game in a corresponding operation phase. Based on this, when the game music of the game is made, the music element library matching the game may be determined first, and then the game music is made based on the music element in the music element library. In this way, the game music is made based on the same music element library, which can largely ensure the unity of the music style of the game music, and is conducive to constructing an overall unified game worldview, achieving the purpose of unifying the style of the game music, realizing the technical effect of enriching the game music making method, and solving the technical problem of the relatively simple processing method for the game music.

The above method in the embodiment is further described below.

As an optional embodiment, at step S203, obtaining, from the music element library, the at least one target music element matching the music attribute includes: determining tone information in the music attribute, where the tone information is set to indicate a tone of the game music played in the target operation phase; and selecting, based on the tone information, the at least one target music element from the music element library.

In this embodiment, the music element library includes a plurality of music elements, and each music element is set to characterize the game operation information of the game in a corresponding operation phase. Based on this, after the music attribute of the game music to be made in the game is determined, the tone information of the music attribute may be further determined, where the tone information is set to indicate a style tone, a scene ambience tone, an emotional tone, or an audio tone of the game music played in the target operation phase. Then, the at least one target music element is selected, based on the tone information, from the music element library.

For example, assuming that the game music to be made in the game is the interface music, then the tone information of the interface music attribute may be determined based on the interface music attribute corresponding to the interface music, where the tone information may include a style tone, an emotional tone, a scene ambience tone, or an audio tone of the game music.

In an embodiment, after the tone information of the game music to be made is determined, at least one music element type set conforming to the tone information may be determined, where each music element type set is set to indicate an expression type of a corresponding music element for the game operation information in the target operation phase.

For example, still taking the game music to be made being the interface music as an example, at least one music element type set conforming to the tone information may be determined from the music element library based on the style tone, the emotional tone, the scene ambience tone, or the audio tone included in the tone information of the interface music attribute.

In an embodiment, after the at least one music element type set is determined, at least one target music element sub-type matching the game operation information in the target operation phase may be respectively determined from the at least one music element type set, where different target music element sub-types express different contents for the game operation information in the target operation phase; and the at least one target music element is obtained by selecting in the music element library a target music element belonging to each target music element sub-type, where the target music element is a musical instrument, a musical instrument group or a natural audio required for making the game music to be made.

For example, as can be seen from the foregoing description, each music element type set includes a plurality of music element sub-types, and each music element sub-type may be set to characterize the game operation information of the game in the target operation phase. Based on this, at least one target music element sub-type matching the game music to be made may be determined, based on the game operation information in the target operation phase in which the game music to be made is running, from the at least one music element type set. Thereafter, a target music element belonging to each target music element sub-type may be selected from the music element library based on the at least one target music element sub-type.

As an optional embodiment, at step S204, outputting the at least one target music element to the music making end includes: determining an audio play result corresponding to each target music element; and outputting, in response to the audio play result satisfying a target audio play result corresponding to the game music, the at least one target music element to the music making end.

In this embodiment, if the target music element is a musical instrument sound, the audio playing tool corresponding to each target music element may be controlled to play, thereby obtaining the audio play result. If the target music element is a natural audio, for example, a metal collision sound, a wind sound, or a rain sound, etc., the natural audio corresponding to each target music element may be directly played to obtain the audio play result.

In an embodiment, after the audio play result of the target music element is obtained, whether the audio play result satisfies the target audio play result corresponding to the game music may be determined. If the audio play result satisfies the target audio play result corresponding to the game music, the at least one target music element may be output to the music making end to make the game music. If the audio play result does not satisfy the target audio play result corresponding to the game music, the step of selecting the target music element may be redirected until the audio play result of the selected target music element satisfies the target audio play result corresponding to the game music, and the target music element is output to the music making end to make the game music.

As an optional embodiments, before the execution of steps S201 to S204, the method further includes: obtaining a plurality of music element type sets, where each of the music element type sets is set to indicate an expression type of a corresponding music element for game operation information in an operation phase, and different music element sub-types in each of the music element type sets express different contents for the game operation information in the operation phase; and organizing a music element conforming to each of the music element type sets into the music element library, where the number of the music element sub-types included in each of the music element type sets may be preset.

In this embodiment, the plurality of music element type sets may be a plurality of music palettes, such as a music palette corresponding to a musical instrument used for the main melody, a music palette corresponding to a musical instrument group used for the ambient layer or the musical background, a music palette corresponding to a musical instrument used for the orchestration, a music palette corresponding to the special design, and a music palette corresponding to the easter egg in the game.

In an embodiment, each music element type set in the plurality of the music element type sets may include a plurality of music element sub-types, i.e., each music palette may include a plurality of music element sub-types. In some embodiments, the music palette corresponding to the musical instrument used for the main melody may include a music type corresponding to the musical instrument used by the protagonist of the game, a music type corresponding to the musical instrument used by the hostile group of the game, a music type corresponding to the overall plot of the game, a music type corresponding to the worldview constructed by the game, etc. The music palette corresponding to the musical instrument group used for the ambient layer or the musical background may include a music type matching the art style of the game, a music type matching the scene ambience of the game, a music type matching the gameplay of the game, and a music type matching the game plot. The music palette corresponding to the musical instrument used for the orchestration may include a music type corresponding to the melody layer, a music type corresponding to the percussion layer, and a music type corresponding to the rhythm layer. The music palette corresponding to the special design may include a music type corresponding to the special plot of the game, a music type corresponding to the special gameplay of the game, and a music type corresponding to the special scene of the game. The music palette corresponding to the easter egg of the game may include a music type corresponding to the special gameplay, and a music type corresponding to the special plot.

In an embodiment, the music elements conforming to each music element type set may be organized into a music element library. In addition, a plurality of music element type sets may be adjusted, and then the music element library may be updated based on the music element type sets as adjusted.

In at least a part of the embodiments of the present disclosure, the music element library may be established, the music element library may include a plurality of music elements, and each music element is set to characterize the game operation information of the game in a corresponding operation phase. Thus, the game music can be made based on the music element in the music element library matching the game. Since the game music of the same game is made based on the music element in the same music element library, this can ensure that there is correlation between the game music as made, achieving the purpose of unifying the music style of the game music, realizing the technical effect of enriching the game music making method, and solving the technical problem of the relatively simple processing method for the game music.

The following provides further examples and introductions for the technical solutions of the embodiments of the present disclosure in combination with the preferred embodiments.

In the related art, the design of the game music used in the game is usually completed based on some music clips that have already been created, and each piece of music in the game may be an independent individual. Based on this, when there is a new scene, a new gameplay or a new plot in the game, it is only required to add music matching a newly added content. The processing method for the game music is relatively simple, and there is often not much correlation required between each piece of music, resulting in disunified styles and tones of the game music, which is not conducive to the creation of an overall unified game worldview.

However, the embodiments of the present disclosure provide a method for processing audio information in a game, where the music element library may be established, the music element library may include a plurality of music elements, and each music element is set to characterize the game operation information of the game in a corresponding operation phase. Based on this, the music attribute of the game music to be made in the game may be determined, where the music attribute may be set to characterize the target operation phase of the game. Then, at least one target music element matching the music attribute may be obtained from the music element library, and the at least one target music element is output to the music making end to make the game music. Since the game music is generated based on the music element library matching the game, this can ensure that the game music as made is correlated with each other, achieving the purpose of unifying the music style of the game music, realizing the technical effect of enriching the game music making method, and solving the technical problem of the relatively simple processing method for the game music.

The music element library in the game music provided in the present disclosure is further described below.

In this embodiment, the music element library may be referred to as a music palette. The game music may be made based on the music palette. In some embodiments, the music palette may include five basic palettes and two special palettes. There is no specific limitation herein to the number of the music palettes.

In an embodiment, the five basic palettes may be a palette corresponding to the musical instrument symbol, a palette corresponding to the musical instrument hint, a palette corresponding to the melody layer, a palette corresponding to the percussion layer, and a palette corresponding to the rhythm layer. The two special palettes may be a palette corresponding to the special design, and a palette corresponding to the easter egg design. In some embodiments, the palette corresponding to the musical instrument symbol includes a musical instrument that can be used in the design of the main melody of the game music. The palette corresponding to the musical instrument hint includes a musical instrument that can be used in the design of the ambient layer music in the game. The palette corresponding to the melody layer includes a musical instrument or a musical instrument group that can be used in the design of the theme melody in the game. The palette corresponding to the percussion layer may include a musical instrument or a musical instrument group that is used in the design of the fight between the protagonist group and the hostile group in the game. The palette corresponding to the rhythm layer may include a musical instrument or a musical instrument group that is used in the design of the key rhythm in the music of the battle between the protagonist group and the hostile group in the game. The palette corresponding to the special design may include a musical instrument or a natural audio that is used in the design of the music corresponding to the special plot, the special gameplay and the special scene in the game. The palette corresponding to the easter egg design may include a special musical instrument that is used in the design of the music corresponding to the special gameplay in the game.

In an embodiment, the palette corresponding to the musical instrument symbol mainly analyzes the kernel of the overall concept text of the game, extracts the keywords of the music concept of the game, where the number of the keywords is no more than 7, and then sets the corresponding musical instrument for each of the extracted keywords. For example, in a national style game, if the extracted keyword is “perish”, a Chinese national musical instrument such as an erhu or a Xiao, which is easy to render a sadness color, may be used as the musical instrument corresponding to the keyword.

In an embodiment, the palette corresponding to the musical instrument hint may avoid the direct use of musical instruments that are clearly correlated with the character or the scene, but provides a more imaginative musical instrument hint palette for certain unique ambiences. For example, in a suspense adventure type game, a certain harp with a worn-out tone color may be used to cooperate with the string plucking to create a sense of dilapidation and a sense of mystery. In a safety camp of the game, a wind musical instrument may be used to play the melody of the background sound part, creating a soothing sense of a safe place, and a sense of the slow passage of time.

In an embodiment, for the palette corresponding to the melody layer, certain sound ranges of the musical instrument group may be used as a fixed palette for the ambience rendering. For example, in an apocalyptic escape game, a low and rough register of the cello and the string bass of the string group may be used to play the melody to create the desolation and danger in the apocalypse, and a middle register of the vocal chorus may be used, where a soft tone color of the middle register of the vocal chorus may be used to play the melody to indicate the remaining hope in the apocalypse, and so on. The specific usage may be chosen based on the worldview of the game.

In an embodiment, the palette corresponding to the percussion layer may use a special percussion group as a fixed palette for certain monsters, races or hostile groups. For example, in a horror adventure game, the metallic percussion may be used in conjunction with the carillon to play the percussion layer to render the arrival of the protagonist.

In an embodiment, the palette corresponding to the rhythm layer may use some fixed rhythmic patterns as a palette to represent special components, mechanisms, information, etc., in the game. For example, in a role playing game (RPG), the tempo and rhythm of a countdown alarm may be analyzed, and a percussion musical instrument may be used to play the tempo in order to mimic the sound of the alarm, while suggesting some potential danger.

In an embodiment, the palette corresponding to the special design may use a change in the acoustic image as the palette to create a unique ambience. For example, in a space theme game, an electronic synthesizer may be used to mimic the emptiness of the space, and slow movement of the acoustic image may be added to show the sense of space. In the background part, some special and accidental weaving changes may be used to create a unique ambience. For example, in the space theme game, some accidental electronic synthesizers and strings may be used to mimic the sound of the engine of the machine operation, which is not easily noticeable due to being set in the background part, but has a good effect on shaping the overall three-dimensional worldview.

In an embodiment, the palette corresponding to the easter egg design, based on the concept of the game worldview, may use some special musical instruments and sounds as a fixed palette to match the gameplay as the easter egg design. For example, in the RPG game, a layer of marimba is added to the scene music, this layer will not be triggered in daily life, and when the player is close to the point of the treasure chest, a special layer will be triggered in order to obtain a sense of achievement of the treasure hunt and exploration.

The method for automatically constructing game music by using a music palette provided by the embodiments of the present disclosure is described below.

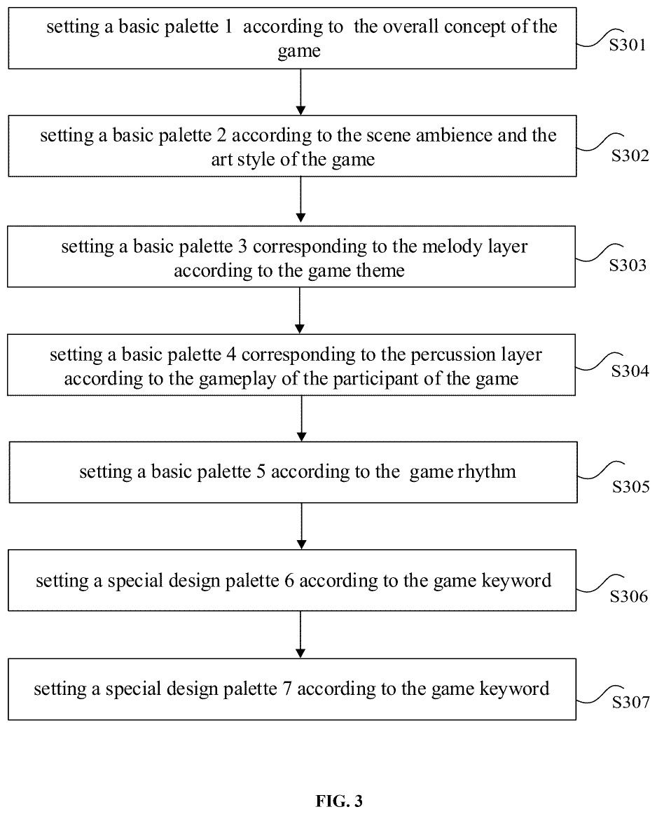

FIG. 3 is a flowchart of a method for automatically constructing game music by using a music palette according to an embodiment of the present disclosure. The method may include the following steps S301 to S307.

At step S301, a basic palette 1 is set according to the overall concept of the game.

In this embodiment, the basic palette 1 may be set according to the overall concept of the game. The basic palette 1 is a palette corresponding to the musical instrument symbol. The musical instrument in the basic palette 1 may be used as the musical instrument for playing the main melody. This can ensure the unity of the style of the game music, and the integrity of the narrative.

In an embodiment, the basic palette 1 may include: a basic palette 101, a musical instrument used by the protagonist group; a basic palette 102, a musical instrument used by the hostile group; a basic palette 103, a musical instrument used by the kernel 01 of the overall concept text; a basic palette 104, a musical instrument used by the kernel 02 of the overall concept text; a basic palette 105, a musical instrument used by the kernel 03 of the overall concept text; a basic palette 106, a musical instrument corresponding to the plot keyword of the game; and a basic palette 107, a musical instrument corresponding to the keyword of the overall worldview of the game.

At step S302, a basic palette 2 is set according to the scene ambience and the art style of the game.

In this embodiment, the basic palette 2 may be set according to the scene ambience tone and the art style of the game. The basic palette 2 is a palette corresponding to the musical instrument hint. The basic palette 2 mainly includes some musical instrument groups set to design the game music according to the background of the game, and the worldview of the game, providing a suggestive emotion and an audio tone.

In an embodiment, the basic palette 2 may include: a basic palette 201, a musical instrument group corresponding to the art style tone of the game; a basic palette 202, a musical instrument group corresponding to the scene ambience tone; a basic palette 203, a musical instrument group corresponding to the gameplay of the game; and a basic palette 204, a musical instrument group corresponding to the game plot.

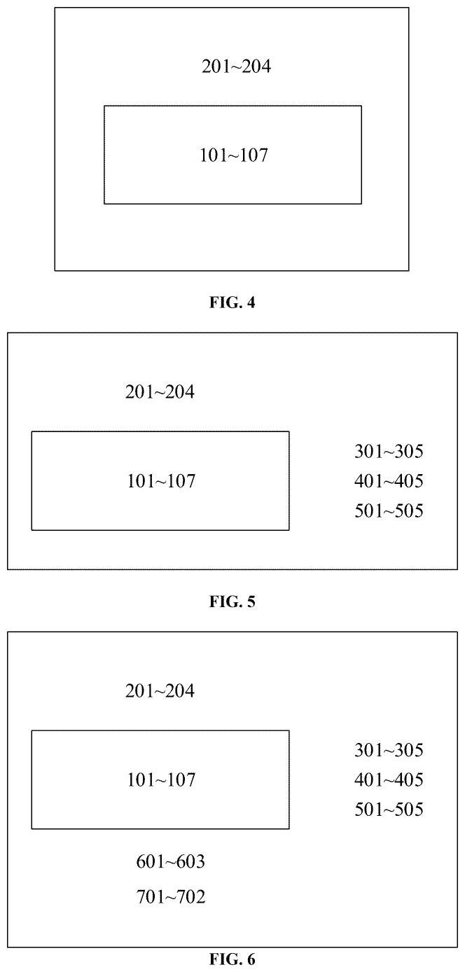

In an embodiment, FIG. 4 is a schematic diagram of a basic palette according to an embodiment of the present disclosure. As shown in FIG. 4, after the above steps S301 and S302, the information included in the basic palettes 101~107, and the information included in the basic palettes 201~204 may be obtained.

At step S303, a basic palette 3 corresponding to the melody layer is set according to the game theme.

In this embodiment, the basic palette 3 may be set according to the theme melody of the game. The basic palette 3 is a palette corresponding to the melody layer. The basic palette 3 may include a musical instrument or a musical instrument group used for a grand theme melody, and a musical instrument or a musical instrument group used for a quarter or a season melody. The difference between the basic palette 3 and the basic palette 1 is that the basic palette 3 does not need to be specific to a particular musical instrument, and may use a certain musical instrument group to represent a certain group or a game keyword.

In an embodiment, the basic palette 3 may include: a basic palette 301, a theme melody (unlimited sound range); a basic palette 302, a quarter/season melody (unlimited sound range); a basic palette 303, a treble register corresponding to the keyword of the game worldview; a basic palette 304, a middle register corresponding to the keyword of the game worldview; and a basic palette 305, a bass register corresponding to the keyword of the game worldview.

At step S304, a basic palette 4 corresponding to the percussion layer is set according to the gameplay of the participant of the game.

In this embodiment, the basic palette 4 may be designed according to the fight between the protagonist group and the hostile group in the game. The basic palette 4 is a palette corresponding to the percussion layer. The basic palette 4 may include some natural audios, for example, a metal percussion sound, or a natural sound such as a wind sound or a rain sound.

In an embodiment, the basic palette 4 may include: a basic palette 401, a musical instrument corresponding to the protagonist; a basic palette 402, a musical instrument corresponding to the protagonist group; a basic palette 403, a musical instrument corresponding to the hostile group 01; a basic palette 404, a musical instrument corresponding to the hostile group 02; and a basic palette 405, a musical instrument corresponding to the hostile group 03.

At step S305, a basic palette 5 is set according to the game rhythm.

In this embodiment, the basic palette 5 may be set according to the game rhythm. The basic palette 5 is a palette corresponding to the rhythm layer. The basic palette 5 may include a musical instrument or a musical instrument group for designing the key rhythm of the music for the battle between the protagonist group and the hostile group.

In an embodiment, the basic palette 5 may include: a basic palette 501, a musical instrument corresponding to the protagonist; a basic palette 502, a musical instrument corresponding to the protagonist group; a basic palette 503, a musical instrument corresponding to the hostile group 01; a basic palette 504, a musical instrument corresponding to the hostile group 02; and a basic palette 505, a musical instrument corresponding to the hostile group 03.

In an embodiment, FIG. 5 is a schematic diagram of another basic palette according to an embodiment of the present disclosure. As shown in FIG. 5, after the above steps S301 to S305, the information included in the basic palettes 101~107, the information included in the basic palettes 201~204, the information included in the basic palettes 301~305, the information included in the basic palettes 401~405, and the information included in the basic palettes 501~505 may be obtained.

At step S306, a special design palette 6 is set according to the game keyword.

In this embodiment, the special design palette 6 may be designed according to the keyword of the plot, the keyword of the gameplay, and the keyword of the scene in the game. The special design palette 6 may be designed from the detail of the game or the ambient background of the game to design the game music, which is not limited to the percussion musical instrument, but may be any sound.

In an embodiment, the special design palette 6 may include: a special palette 601, a sound corresponding to the plot keyword; a special palette 602, a sound corresponding to the gameplay keyword; and a special palette 603, a sound corresponding to the scene keyword.

At step S307, a special design palette 7 is set according to the game keyword.

In this embodiment, the special design palette 7 may be designed according to the keyword of the gameplay, and the keyword of the plot in the game, which may be a certain rhythmic pattern and a certain special musical instrument, providing the player with a feeling of deciphering and discovering the easter egg.

In an embodiment, the special design palette 7 may include: a special palette 701, a sound corresponding to the gameplay keyword; and a special palette 702, a sound corresponding to the plot keyword.

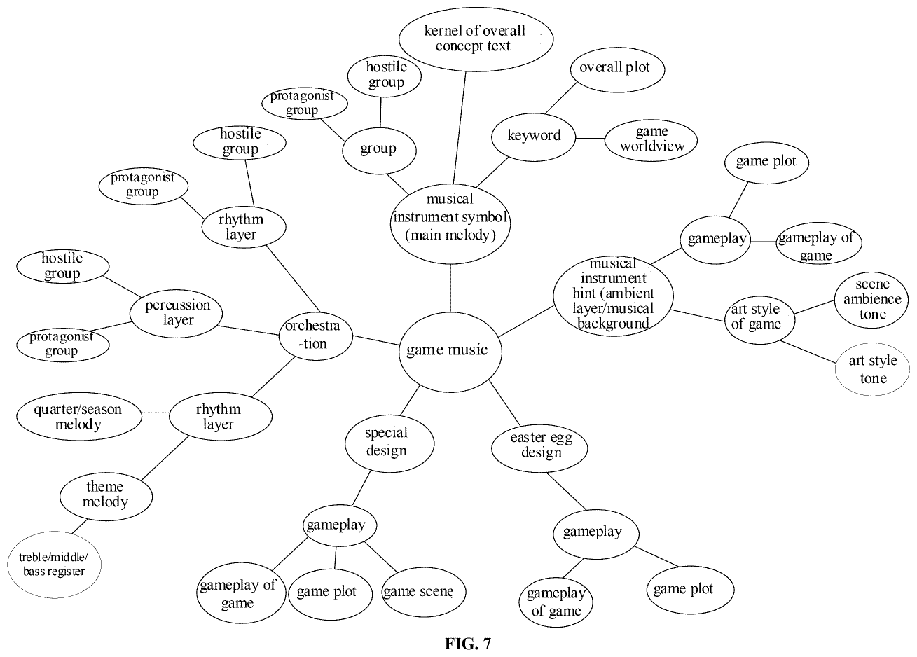

In an embodiment, FIG. 6 is a schematic diagram of another basic palette according to an embodiment of the present disclosure. As shown in FIG. 6, after the above steps S301 to S305, the information included in the basic palettes 101~107, the information included in the basic palettes 201~204, the information included in the basic palettes 301~305, the information included in the basic palettes 401~405, the information included in the basic palettes 501~505, the information included in the basic palettes 601~603, and the information included in the basic palettes 701~702 may be obtained.

In an embodiment, the above steps S301~S307 are only one possible execution order, and of course, there may be other execution orders, which are not specifically limited herein.

The design method for the interface music to be made in the game is further described below.

The design method for the interface music: triggering the above 301 to obtain the theme melody of the game music to be made, triggering the above 101 to obtain the musical instrument corresponding to the protagonist in the main melody, selectively triggering, based on the current game plot, one of the above 103~105, one of the above 401~402, or one of the above 501~502, obtaining the orchestration used for the main melody, and making the interface music based on the musical instrument and the sound as obtained.

The design method for the battle music to be made in the game is further described below.

The design method for the battle music for the gameplay: triggering the above 101 to obtain the musical instrument used by the protagonist in the game, triggering the above 102 to obtain the musical instrument used by the hostile group in the game, triggering the above 203 to obtain the musical instrument group corresponding to the gameplay of the game, triggering one of the above 303~305 to obtain the register corresponding to the game worldview, triggering one of the above 403~405 to obtain the musical instrument used by the hostile group in the percussion layer, and making the battle music based on the musical instrument and the sound as obtained.

The design method for the plot music to be made in the game is further described below.

The design method for the plot music: taking the design of the main plot music as an example, triggering the above 101 to obtain the musical instrument used by the protagonist in the game, triggering one of the above 106~107 to obtain the musical instrument corresponding to the plot keyword of the game, triggering one of the above 303~305 to obtain the corresponding register of the game worldview, triggering one of the above 401~402 to obtain the musical instrument corresponding to the protagonist group in the percussion layer, triggering one of the above 501~502 to obtain the musical instrument corresponding to the protagonist group in the rhythm layer, triggering the above 601 to obtain the sound corresponding to the plot keyword, and making the plot music based on the musical instrument and the sound as obtained.

The design method for the scene music to be made in the game is further described below.

The design method for the scene music: taking the design of the special scene music as an example, triggering the above 101 to obtain the musical instrument used by the protagonist in the game, triggering one of the above 401~402 to obtain the musical instrument corresponding to the protagonist group in the percussion layer, triggering one of the above 501~502 to obtain the musical instrument corresponding to the protagonist group in the rhythm layer, and making the scene music based on the musical instrument and the sound as obtained.

The design method for the theme music to be made in the game is further described below.

The design method for the theme music: taking the design of the main game music corresponding to the protagonist as an example, triggering the above 101 to obtain the musical instrument used by the protagonist in the game, and triggering the above 401 to obtain the musical instrument used by the protagonist in the percussion layer.

The palette used for automatically constructing the game music is described below. FIG. 7 is a schematic diagram of another music palette corresponding to game music according to an embodiment of the present disclosure. As shown in FIG. 7, the music palette that can be used for designing a piece of game music includes a musical instrument symbol palette, a musical instrument hint palette, an orchestration palette, a special design palette, and an easter egg design palette. The musical instrument symbol palette is mainly set to design the main melody of the game. The musical instrument hint palette is mainly set to design the ambient layer music or the musical background in the game music. The orchestration palette is mainly set to design the music of the rhythm layer, the music of the percussion layer, and the music of the melody layer in the game. The special design palette is mainly set to design the music for the special gameplay in the game. The easter egg design palette is also set to design the music for the special gameplay in the game, which adds a sense of mystery to the game. In some embodiments, the musical instrument symbol palette includes the musical instrument used by the protagonist group and the hostile group, the musical instrument corresponding to the kernel of the concept text of the game, and the musical instrument corresponding to the game worldview and the overall plot of the game. The musical instrument hint palette includes the musical instrument or the musical instrument group corresponding to the gameplay of the game and the game plot, and further includes the musical instrument corresponding to the art style of the game and the scene ambience tone. The palette corresponding to the orchestration includes the musical instrument corresponding to the protagonist group and the hostile group in the rhythm layer, the musical instrument corresponding to the protagonist group and the hostile group in the percussion layer, the musical instrument used for the quarter or season melody in the melody layer, and the musical instrument used for the theme melody. The palette corresponding to the special design includes the musical instrument or the audio corresponding to the gameplay of the game, the game plot, and the game scene. The palette corresponding to the easter egg design includes the musical instrument corresponding to the gameplay of the game, and the game plot. Based on the various musical instruments or audios provided in the above respective music palettes, the game music can be designed, and the design method for the game music can be enriched, solving the technical problem of the relatively simple design method for the game music.

Through the description of the above embodiments, those skilled in the art can clearly understand that the method according to the above embodiments may be realized with the aid of software plus a necessary general hardware platform, or of course by means of hardware, but in many cases the former is the better embodiment. Based on this understanding, the technical solutions of the present disclosure essentially, or the part of the technical solutions of the present disclosure that contributes to the related art may be embodied in the form of a software product. The computer software product is stored in a storage medium (e.g., a ROM/RAM, a magnetic disc, a CD-ROM) including one or more instructions to cause a terminal device (which may be a cellular phone, a computer, a server, or a network device, etc.) to perform the method described in the embodiments of the present disclosure.

The embodiment further provides an apparatus for processing audio information in a game. The apparatus is configured for implementing the above-described embodiments and the preferred embodiments, which have already been described without further elaboration. As used hereinafter, the terms “unit”, “module” may be a combination of software and/or hardware that implements a preset function. Although the apparatus described in the following embodiments are preferably implemented in software, implementations in hardware, or combinations of software and hardware, are also possible and contemplated.

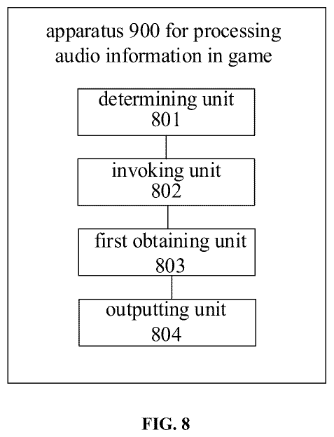

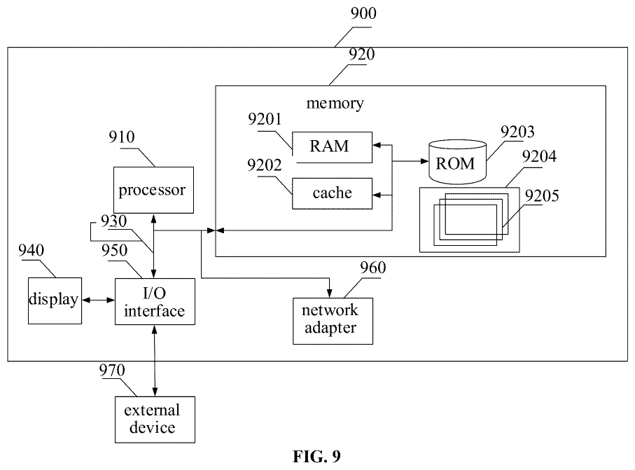

FIG. 8 is a block diagram of a structure of an apparatus for processing audio information in a game according to an embodiment of the present disclosure. As shown in FIG. 8, the apparatus includes a determining unit 801, an invoking unit 802, a first obtaining unit 803, and an outputting unit 804.

The determining unit 801 is set to determine a music attribute of game music to be made in the game, where the music attribute is set to characterize a target operation phase of the game.

The invoking unit 802 is set to invoke a music element library matching the game, where the music element library includes a plurality of music elements, and each of the music elements is set to characterize game operation information of the game in a corresponding operation phase.

The first obtaining unit 803 is set to obtain, from the music element library, at least one target music element matching the music attribute.

The outputting unit 804 is set to output the at least one target music element to a music making end, where the at least one target music element is set to be made on the music making end into the game music, and the game music is set to prompt game operation information.

In an embodiment, the first obtaining unit 803 includes: a first determining module set to determine tone information in the music attribute, where the tone information is set to indicate a tone of the game music played in the target operation phase; and a selecting module set to select, based on the tone information, the at least one target music element from the music element library.

In an embodiment, the selecting module includes: a determining sub-module set to determine at least one music element type set conforming to the tone information, where each music element type set is set to indicate an expression type of a corresponding music element for the game operation information in the target operation phase; and a selecting sub-module set to select, based on the at least one music element type set, the at least one target music element from the music element library.

In an embodiment, the selecting sub-module is further set to: determine, from the at least one music element type set, at least one target music element sub-type matching the game operation information in the target operation phase respectively, where different target music element sub-types express different contents for the game operation information in the target operation phase; and obtain, by selecting in the music element library a target music element belonging to each target music element sub-type, the at least one target music element.

In an embodiment, the apparatus 800 further includes: a second obtaining unit set to obtain a plurality of music element type sets, where each of the music element type sets is set to indicate an expression type of a corresponding music element for game operation information in an operation phase, and different music element sub-types in each of the music element type sets express different contents for the game operation information in the operation phase; and an establishing unit set to organize a music element conforming to each of the music element type sets into the music element library.

In an embodiment, the apparatus 800 further includes: an adjusting unit set to adjust the plurality of the music element type sets; and an updating unit set to update the music element library based on the music element type sets as adjusted.

In an embodiment, the outputting unit 804 includes: a second determining module set to determine an audio play result corresponding to each target music element; and an outputting module set to output, in response to the audio play result satisfying a target audio play result corresponding to the game music, the at least one target music element to the music making end.

In an embodiment, the second determining module includes a controlling sub-module set to: obtain the audio play result by controlling an audio playing tool corresponding to each target music element to play; and/or obtain the audio play result by playing a target natural audio corresponding to each target music element.

In an embodiment, the music attribute includes at least one of the following: an interface music attribute, a battle music attribute, a plot music attribute, a scene music attribute, a theme music attribute, and an animation music attribute.

In an embodiment, the game operation information includes at least one of the following of the game: a group to which a virtual game character belongs, a game keyword, a game theme, a match quarter, a game plot, a game style, and a game operation.

In the apparatus for processing audio information in a game in the embodiment, the determining unit is set to determine a music attribute of game music to be made in the game; the invoking unit is set to invoke a music element library matching the game, where the music element library includes a plurality of music elements, and each of the music elements is set to characterize game operation information of the game in a corresponding operation phase; the first obtaining unit is set to obtain, from the music element library, at least one target music element matching the music attribute; and the outputting unit is set to output the at least one target music element to a music making end, where the at least one target music element is set to be made on the music making end into the game music. That is to say, in the embodiment of the present disclosure, the game music of respective operation phases of the game is designed based on the music element library matching the game. The style of the game music designed in this way is relatively unified, which is conducive to the creation of an overall unified game worldview, achieving the purpose of unifying the style of the game music, realizing the technical effect of enriching the game music making method, thereby solving the technical problem of the relatively simple processing method for the game music.

It should be noted that each of the above units and modules may be implemented by software or hardware, and for the latter, the implementation may be realized in the following manner, without limitation: the above units and modules are all located in the same processor; or the above units and modules are located in different processors in the form of any combination.

The embodiments of the present disclosure further provide a computer-readable storage medium. The computer-readable storage medium stores a computer program, where the computer program is set to perform, when it is run, the steps in any of the method embodiments described above.

In this embodiment, the above computer-readable storage medium may include, but is not limited to, various media that can store the computer program, such as a USB flash drive, a read-only memory (ROM for short), a random access memory (RAM for short), a removable hard disk, a magnetic disc, or an optical disk.

In this embodiment, the above computer-readable storage medium may be located in any one computer terminal in the computer terminal group in the computer network, or in any one mobile terminal in the mobile terminal group.

In this embodiment, the above computer-readable storage medium may be set to store a computer program set to perform the following steps S1 to S4.

At S1, a music attribute of game music to be made in the game is determined, where the music attribute is set to characterize a target operation phase of the game.

At S2, a music element library matching the game is invoked, where the music element library includes a plurality of music elements, and each of the music elements is set to characterize game operation information of the game in a corresponding operation phase.

At S3, at least one target music element matching the music attribute is obtained from the music element library.

At S4, the at least one target music element is output to a music making end, where the at least one target music element is set to be made on the music making end into the game music, and the game music is set to prompt game operation information in the target operation phase.

In an embodiment, the above computer-readable storage medium may be set to store a computer program set to perform the following steps: determining tone information in the music attribute, where the tone information is set to indicate a tone of the game music played in the target operation phase; and selecting, based on the tone information, the at least one target music element from the music element library.

In an embodiment, the above computer-readable storage medium may be set to store a computer program set to perform the following steps: determining at least one music element type set conforming to the tone information, where each music element type set is set to indicate an expression type of a corresponding music element for the game operation information in the target operation phase; and selecting, based on the at least one music element type set, the at least one target music element from the music element library.

In an embodiment, the above computer-readable storage medium may be set to store a computer program set to perform the following steps: determining, from the at least one music element type set, at least one target music element sub-type matching the game operation information in the target operation phase respectively, where different target music element sub-types express different contents for the game operation information in the target operation phase; and obtaining, by selecting in the music element library a target music element belonging to each target music element sub-type, the at least one target music element.

In an embodiment, the above computer-readable storage medium may be set to store a computer program set to perform the following steps: obtaining a plurality of music element type sets, where each of the music element type sets is set to indicate an expression type of a corresponding music element for game operation information in an operation phase, and different music element sub-types in each of the music element type sets express different contents for the game operation information in the operation phase; and organizing a music element conforming to each of the music element type sets into the music element library.

In an embodiment, the above computer-readable storage medium may be set to store a computer program set to perform the following steps: adjusting the plurality of the music element type sets; and updating the music element library based on the music element type sets as adjusted.

In an embodiment, the above computer-readable storage medium may be set to store a computer program set to perform the following steps: determining an audio play result corresponding to each target music element; and outputting, in response to the audio play result satisfying a target audio play result corresponding to the game music, the at least one target music element to the music making end.

In an embodiment, the above computer-readable storage medium may be set to store a computer program set to perform the following steps: obtaining the audio play result by controlling an audio playing tool corresponding to each target music element to play; and/or obtaining the audio play result by playing a target natural audio corresponding to each target music element.

In the computer-readable storage medium of the embodiment, a method for processing audio information in a game is provided, where the music element library may be generated, the music element library includes a plurality of music elements, and each music element is set to characterize the game operation information of the game in a corresponding operation phase. Thus, the game music can be made based on the music element in the music element library matching the game. Since the game music of the same game is made based on the music element in the same music element library, this can ensure that there is correlation between the game music as made, achieving the purpose of unifying the style of the game music. Designing the game music by using the music element library can also realize the technical effect of enriching the game music, solving the technical problem of the relatively simple processing method for the game music.

Through the description of the above embodiments, those skilled in the art can easily understand that the embodiments described herein may be realized by means of software, or by means of software combined with the necessary hardware. Thus, the technical solution according to the embodiments of the present disclosure may be embodied in the form of a software product. The software product may be stored in a computer-readable storage medium (which may be a CD-ROM, a USB flash drive, a removable hard disk, etc.) or a network, and include one or more instructions to cause a computing device (which may be a personal computer, a server, a terminal device, or a network device, etc.) to perform the method according to the embodiments of the present disclosure.

In an embodiment of the present disclosure, the computer-readable storage medium stores a program product capable of implementing the above method of the embodiment. In some possible embodiments, aspects of the embodiments of the present disclosure may also be realized in the form of a program product including program code which, when run on a terminal device, is used for causing the terminal device to perform the steps according to various embodiments of the present disclosure as described in the above-described “method” portion of the embodiment.

The program product for implementing the above methods according to the embodiments of the present disclosure may be in the form of a portable compact disc read-only memory (CD-ROM) and include program code, and may be run on a terminal device, such as a personal computer. However, the program product of the embodiments of the present disclosure is not limited thereto. In the embodiments of the present disclosure, the computer-readable storage medium may be any tangible medium including or storing a program that may be used by or in combination with an instruction execution system, apparatus or device.

The above program product may use any combination of one or more computer-readable media. The computer-readable storage medium may, for example, be, but is not limited to, an electrical, magnetic, optical, electromagnetic, infrared, or semiconductor system, apparatus or device, or any combination thereof. More specific examples of the computer-readable storage medium (a non-exhaustive enumeration) include: an electrical connection having one or more wires, a portable disk, a hard disk, an RAM, an ROM, an erasable programmable read-only memory (EPROM or flash memory), a fiber optic, a portable compact disc read-only memory (CD-ROM), an optical storage device, a magnetic storage device, or any suitable combination of the foregoing.

It should be noted that the program code included in the computer-readable storage medium may be transmitted by using any suitable medium, including, but not limited to, wireless line, wired line, optical fiber, RF, and the like, or any suitable combination of the foregoing.

The embodiments of the present disclosure further provide an electronic device including a memory and a processor. The memory stores a computer program. The processor is set to run the computer program to perform the steps in any of the method embodiments described above.

In an embodiment, the above electronic device may further include a transmission device and an input/output device, where the transmission device is connected to the above processor, and the input/output device is connected to the above processor.

In this embodiment, the above processor may be set to perform the following steps S1 to S4 via the computer program.

At S1, a music attribute of game music to be made in the game is determined, where the music attribute is set to characterize a target operation phase of the game.

At S2, a music element library matching the game is invoked, where the music element library includes a plurality of music elements, and each of the music elements is set to characterize game operation information of the game in a corresponding operation phase.

At S3, at least one target music element matching the music attribute is obtained from the music element library.

At S4, the at least one target music element is output to a music making end, where the at least one target music element is set to be made on the music making end into the game music, and the game music is set to prompt game operation information in the target operation phase.

In an embodiment, the above processor may be set to perform the following steps via the computer program: determining tone information in the music attribute, where the tone information is set to indicate a tone of the game music played in the target operation phase; and selecting, based on the tone information, the at least one target music element from the music element library.

In an embodiment, the above processor may be set to store the computer program set to perform the following steps: determining at least one music element type set conforming to the tone information, where each music element type set is set to indicate an expression type of a corresponding music element for the game operation information in the target operation phase; and selecting, based on the at least one music element type set, the at least one target music element from the music element library.

In an embodiment, the above processor may be set to store the computer program set to perform the following steps: determining, from the at least one music element type set, at least one target music element sub-type matching the game operation information in the target operation phase respectively, where different target music element sub-types express different contents for the game operation information in the target operation phase; and obtaining, by selecting in the music element library a target music element belonging to each target music element sub-type, the at least one target music element.

In an embodiment, the above processor may be set to store the computer program set to perform the following steps: obtaining a plurality of music element type sets, where each of the music element type sets is set to indicate an expression type of a corresponding music element for game operation information in an operation phase, and different music element sub-types in each of the music element type sets express different contents for the game operation information in the operation phase; and organizing a music element conforming to each of the music element type sets into the music element library.

In an embodiment, the above processor may be set to store the computer program set to perform the following steps: adjusting the plurality of the music element type sets; and updating the music element library based on the music element type sets as adjusted.

In an embodiment, the above processor may be set to store the computer program set to perform the following steps: determining an audio play result corresponding to each target music element; and outputting, in response to the audio play result satisfying a target audio play result corresponding to the game music, the at least one target music element to the music making end.

In an embodiment, the above processor may be set to store the computer program set to perform the following steps: obtaining the audio play result by controlling an audio playing tool corresponding to each target music element to play; and/or obtaining the audio play result by playing a target natural audio corresponding to each target music element.

In the electronic device of the embodiment, the music element library may be generated, the music element library includes a plurality of music elements, and each music element is set to characterize the game operation information of the game in a corresponding operation phase. Thus, the game music can be made based on the music element in the music element library matching the game. Since the game music of the same game is made based on the music element in the same music element library, this can ensure that there is correlation between the game music as made, achieving the purpose of unifying the style of the game music. Designing the game music by using the music element library can also realize the technical effect of enriching the game music, solving the technical problem of the relatively simple processing method for the game music.

FIG. 9 is a schematic diagram of an electronic device according to an embodiment of the present disclosure. As shown in FIG. 9, the electronic device 900 is merely an example, and should not bring any limitation to the function and scope of use of the embodiments of the present disclosure.

As shown in FIG. 9, the electronic device 900 is represented in the form of a general purpose computing device. The components of the electronic device 900 may include, but are not limited to, at least one processor 910, the at least one memory 920, a bus 930 connected to different system components (including the memory 920 and the processor 910), and a display 940.

In some embodiments, the memory 920 stores program code, and the program code may be executed by the processor 910, causing the processor 910 to perform the steps described in the method part of the embodiments of the present disclosure according to various example embodiments of the present disclosure.

The memory 920 may include a readable medium in the form of a volatile storage unit, for example, an RAM 9201 and/or a cache storage unit 9202. The memory 920 may further include an ROM 9203, or may include a non-volatile memory, such as one or more magnetic storage apparatuses, flash memories, or other non-volatile solid-state memories.

In some examples, the memory 920 may further include a program/utility tool 9204 having a set of (at least one) program modules 9205. Such program module 9205 includes, but is not limited to, an operating system, one or more application programs, other program modules, and program data. Each of these examples or a certain combination of these examples may include an implementation of a network environment. The memory 920 may further include memories remotely disposed relative to the processor 910, and the remote memories may be connected to the electronic device 900 through a network. Examples of the network include, but are not limited to, the Internet, an intranet, a local area network, a mobile communication network, and a combination of them.

The bus 930 may be one or more of several types of bus structures, including a memory unit bus or a memory unit controller, a peripheral bus, a graphics acceleration port, a processor 910, or a local bus using any of a plurality of bus structures.

The display 940 may, for example, be a touch screen type liquid crystal display (LCD), which may enable a user to interact with a user interface of the electronic device 900.

In an embodiment, the electronic device 900 may also communicate with one or more external devices 970 (e.g. a keyboard, a pointing device, a Bluetooth device, etc.), may also communicate with one or more devices that enable a user to interact with the electronic device 900, and/or, may communicate with any device (e.g. a router, a modem, etc.) that enables the electronic device 900 to communicate with one or more other computing devices. Such communication may be performed via an input/output (I/O) interface 950. In addition, the electronic device 900 may communicate, through a network adapter 960, with one or more networks, for example, a local area network (LAN), a wide area network (WAN), and/or a public network such as the Internet. As shown in FIG. 9, the network adapter 960 communicates with other modules of electronic device 900 via the bus 930. It should be understood that although not shown in FIG. 9, other hardware and/or software modules may be used in combination with the electronic device 900, and the modules may include, but are not limited to, microcode, a device driver, a redundancy processing unit, an external disk drive array, an RAID system, a tape drive, a data backup storage system, or the like.

The electronic device 900 may further include a keyboard, a cursor control device (such as a mouse), an I/O interface, a network interface, a power supply, and/or a camera.

Those ordinary skilled in the art may understand that the structure shown in FIG. 9 is merely an example, and does not limit the structure of the electronic device. For example, the electronic device 900 may further include more or fewer components than those shown in FIG. 9, or have a configuration different from that shown in FIG. 1. The memory 920 may be configured to store a computer program and corresponding data, for example, a computer program and corresponding data corresponding to the method for processing audio information in a game in the embodiments of the present disclosure. The processor 910 performs various functional applications and data processing by running the computer program stored in the memory 920, that is, to implement the foregoing method for processing audio information in a game.

The sequence numbers of the above embodiments of the present disclosure are merely for description, and do not represent the advantages and disadvantages of the embodiments.

In the above embodiments of the present disclosure, the description of each embodiment has its own emphasis. For the parts that are not described in detail in an embodiment, reference may be made to related descriptions of other embodiments.

In the several embodiments provided in the present disclosure, it should be understood that the disclosed technical content may be implemented in other manners. In some embodiments, the device embodiments described above are merely illustrative. For example, the division of the units may be a logical function division, and there may be another division manner in actual implementations. For example, a plurality of units or components may be combined or may be integrated into another system, or some features may be ignored or not performed. In addition, the displayed or discussed mutual coupling or direct coupling or communication connection may be indirect coupling or communication connection between units or modules through some interfaces, and may be electrical or in other forms.

The units described as separate parts may or may not be physically separate. Components displayed as units may or may not be physical units, i.e., may be located in one position, or may be distributed on a plurality of units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such understanding, the technical solutions of the present disclosure essentially, or the part of the technical solutions of the present disclosure that contributes to the related art, or all or a part of the technical solution may be embodied in the form of a software product. The computer software product is stored in a storage medium and includes one or more instructions to cause a computer device (which may be a personal computer, a server, a network device, etc.) to perform all or a part of the steps of the methods described in the embodiments of the present disclosure. The foregoing storage medium includes various media that can store program code, such as a USB flash drive, an ROM, an RAM, a removable hard disk, a magnetic disc, or an optical disk.

The above description is only the preferred embodiment of the present disclosure. It should be noted that, for those ordinary skilled in the art, one or more improvements and modifications may be made without departing from the principle of the present disclosure, and these improvements and modifications should also be considered as the scope of protection of the present disclosure.

1. A method for processing audio information in a game, comprising:
determining a music attribute of game music to be made in the game, wherein the music attribute is set to characterize a target operation phase of the game;
invoking a music element library matching the game, wherein the music element library comprises a plurality of music elements, and each of the music elements is set to characterize game operation information of the game in a corresponding operation phase;
obtaining, from the music element library, at least one target music element matching the music attribute; and
outputting the at least one target music element to a music making end, wherein the at least one target music element is set to be made on the music making end into the game music, and the game music is set to prompt game operation information in the target operation phase.

2. The method according to claim 1, wherein the obtaining, from the music element library, the at least one target music element matching the music attribute comprises:
determining tone information in the music attribute, wherein the tone information is set to indicate a tone of the game music played in the target operation phase; and
selecting, based on the tone information, the at least one target music element from the music element library.

3. The method according to claim 2, wherein the selecting, based on the tone information, the at least one target music element from the music element library comprises:
determining at least one music element type set conforming to the tone information, wherein each music element type set is set to indicate an expression type of a corresponding music element for the game operation information in the target operation phase; and
selecting, based on the at least one music element type set, the at least one target music element from the music element library.

4. The method according to claim 3, wherein the selecting, based on the at least one music element type set, the at least one target music element from the music element library comprises:
determining, from the at least one music element type set, at least one target music element sub-type matching the game operation information in the target operation phase respectively, wherein different target music element sub-types express different contents for the game operation information in the target operation phase; and
obtaining, by selecting in the music element library a target music element belonging to each target music element sub-type, the at least one target music element.

5. The method according to claim 1, further comprising:
obtaining a plurality of music element type sets, wherein each of the music element type sets is set to indicate an expression type of a corresponding music element for game operation information in an operation phase, and different music element sub-types in each of the music element type sets express different contents for the game operation information in the operation phase; and
organizing a music element conforming to each of the music element type sets into the music element library.

6. The method according to claim 5, further comprising:
adjusting the plurality of the music element type sets; and
updating the music element library based on the music element type sets as adjusted.

7. The method according to claim 1, wherein the outputting the at least one target music element to the music making end comprises:
determining an audio play result corresponding to each target music element; and
outputting, in response to the audio play result satisfying a target audio play result corresponding to the game music, the at least one target music element to the music making end.

8. The method according to claim 7, wherein the determining the audio play result corresponding to each target music element comprises:
obtaining the audio play result by controlling an audio playing tool corresponding to each target music element to play.

9. The method according to claim 1, wherein the music attribute comprises at least one of: an interface music attribute, a battle music attribute, a plot music attribute, a scene music attribute, a theme music attribute, or an animation music attribute.

10. The method according to claim 1, wherein the game operation information comprises at least one of the following of the game: a group to which a virtual game character belongs, a game keyword, a game theme, a match quarter, a game plot, a game style, or a game operation.

11. (canceled)

12. A non-transitory computer-readable storage medium, storing a computer program that, when executed by a processor, causes the processor to perform a method for processing audio information in a game, wherein the method comprises:
determining a music attribute of game music to be made in the game, wherein the music attribute is set to characterize a target operation phase of the game;
invoking a music element library matching the game, wherein the music element library comprises a plurality of music elements, and each of the music elements is set to characterize game operation information of the game in a corresponding operation phase;
obtaining, from the music element library, at least one target music element matching the music attribute; and
outputting the at least one target music element to a music making end, wherein the at least one target music element is set to be made on the music making end into the game music, and the game music is set to prompt game operation information in the target operation phase.

13. An electronic device, comprising a memory and a processor, wherein the memory stores a computer program executable by the processor, and the processor, through executing the computer program, is configured to:
determine a music attribute of game music to be made in a game, wherein the music attribute is set to characterize a target operation phase of the game;
invoke a music element library matching the game, wherein the music element library comprises a plurality of music elements, and each of the music elements is set to characterize game operation information of the game in a corresponding operation phase;
obtain, from the music element library, at least one target music element matching the music attribute; and
output the at least one target music element to a music making end, wherein the at least one target music element is set to be made on the music making end into the game music, and the game music is set to prompt game operation information in the target operation phase.

14. The method according to claim 7, wherein the determining the audio play result corresponding to each target music element comprises:
obtaining the audio play result by playing a target natural audio corresponding to each target music element.

15. The electronic device according to claim 13, wherein the processor is specifically configured to:
determine tone information in the music attribute, wherein the tone information is set to indicate a tone of the game music played in the target operation phase; and
select, based on the tone information, the at least one target music element from the music element library.

16. The electronic device according to claim 15, wherein the processor is specifically configured to:
determine at least one music element type set conforming to the tone information, wherein each music element type set is set to indicate an expression type of a corresponding music element for the game operation information in the target operation phase; and
select, based on the at least one music element type set, the at least one target music element from the music element library.

17. The electronic device according to claim 16, wherein the processor is specifically configured to:
determine, from the at least one music element type set, at least one target music element sub-type matching the game operation information in the target operation phase, wherein different target music element sub-types express different contents for the game operation information in the target operation phase; and
obtain, by selecting in the music element library a target music element belonging to each target music element sub-type, the at least one target music element.

18. The electronic device according to claim 13, wherein the processor is further configured to:
obtain a plurality of music element type sets, wherein each of the music element type sets is set to indicate an expression type of a corresponding music element for game operation information in an operation phase, and different music element sub-types in each of the music element type sets express different contents for the game operation information in the operation phase; and
organize a music element conforming to each of the music element type sets into the music element library.

19. The non-transitory computer-readable storage medium according to claim 12, wherein the obtaining, from the music element library, the at least one target music element matching the music attribute comprises:
determining tone information in the music attribute, wherein the tone information is set to indicate a tone of the game music played in the target operation phase; and
selecting, based on the tone information, the at least one target music element from the music element library.

20. The non-transitory computer-readable storage medium according to claim 19, wherein the selecting, based on the tone information, the at least one target music element from the music element library comprises:
determining at least one music element type set conforming to the tone information, wherein each music element type set is set to indicate an expression type of a corresponding music element for the game operation information in the target operation phase; and
selecting, based on the at least one music element type set, the at least one target music element from the music element library.

21. The non-transitory computer-readable storage medium according to claim 20, wherein the selecting, based on the at least one music element type set, the at least one target music element from the music element library comprises:
determining, from the at least one music element type set, at least one target music element sub-type matching the game operation information in the target operation phase, wherein different target music element sub-types express different contents for the game operation information in the target operation phase; and
obtaining, by selecting in the music element library a target music element belonging to each target music element sub-type, the at least one target music element.
